(19) United States
(12) Patent Application Publication
(10) Pub. No.: US 2025/0332750 A1
(43) Pub. Date: Oct. 30, 2025

(54) ELECTRIC HAIR CUTTING DEVICE HAVING USER INPUT DEPENDENT SPEED CONTROL

(71) Applicant: WAHL CLIPPER CORPORATION, Sterling, IL (US)

(72) Inventors: Michael F. WAHL, Sterling, IL (US); Dhiraj BASNET, Dixon, IL (US)

(21) Appl. No.: 19/083,801

(22) Filed: Mar. 19, 2025

Related U.S. Application Data
(60) Provisional application No. 63/638,996, filed on Apr. 26, 2024.

(51) Int. Cl. B26B 19/38; B26B 19/04; B26B 19/28

(52) U.S. Cl. CPC B26B 19/388; B26B 19/04; B26B 19/3886; B26B 19/28

(57) ABSTRACT

An electric hair cutting device including a housing having a first end and a second end opposite the first end, a bladeset mounted to the housing at the first end, the bladeset having a stationary blade and a reciprocating blade, an electric motor electrically connected to a power source within the housing, a drive shaft operatively connecting the electric motor to the reciprocating blade, a control module within the housing which controls a rotational speed of the electric motor; and a trigger which sends an actuation signal to the control module based on a partial actuation of the trigger between a minimum actuation and a maximum actuation, the control module adjusting a rotational speed of the electric motor based on the actuation signal.

### RELATED APPLICATION

The present application claims the benefit under 35 USC 119(e) of U.S. Provisional Application No. 63/638,996 filed Apr. 26, 2024, the entire contents of which are incorporated by reference herein.

### BACKGROUND

The present invention relates to electric hair cutting devices, and more particularly to such a device featuring user-initiated adjustable motor speed control.

Electric hair cutting devices such as shavers, or hair clippers and trimmers (the latter two being used interchangeably herein), are common tools for both professional hairstylists and barbers, as well as for personal grooming at home or for grooming animals. These devices typically include an electric motor that drives the cutting blades to trim or cut hair. The performance of an electric hair cutting device is highly dependent on the speed of its electric motor, which directly controls the movement of a moving cutting blade, and thus influences the cutting efficiency, the quality of the haircut, and the user's overall experience.

Such devices often have a single or limited number of motor speed settings, which often is not suitable for all hair types, cutting techniques, or user preferences. For example, certain hair types, such as thick or coarse hair, require a higher motor speed for effective cutting, while other hair types, such as fine or thin hair, require a lower motor speed for better control and precision. Additionally, professional hairstylists and barbers often prefer multiple motor speeds to accommodate various cutting techniques and styles. However, conventional electric hair cutting devices have a limited capability for motor speed adjustment.

Additionally, operating electric hair cutting devices at a faster speed typically results in increased heat, vibration, and noise being generated by the electric motor, and may result in faster wear of the internal components. Additionally, relating to battery-powered hair clippers, operating the hair clipper at faster speeds drains the battery within the hair clipper more quickly.

Some attempts have been made to address this issue, such as providing hair clippers with multiple discrete speed settings. However, these solutions often add complexity to the device, increase manufacturing costs, and often do not offer the desired range, or precise control, of motor speeds for all users. Further, with discrete speed settings, many barbers and stylists may need to halt a current cutting pass to carefully change the speed of the motor using a switch, dial, etc., of the device before returning to that pass, which can lead to blending line visibility or inaccuracies.

Accordingly, there is a need in the art for a device that addresses the above challenges and needs in the current state of the art.

### SUMMARY

The above-listed need is met or exceeded by the present electric hair cutting device having on demand user input variable speed control. Specifically, the present electric hair cutting device, in the form of a hair trimmer, includes a trigger which is partially actuated between a minimum actuation and a maximum actuation of the trigger. Based on this partial actuation, the trigger sends an actuation signal to a control module of the hair trimmer, which sends a control signal to the electric motor to increase a rotational speed of an eccentric cam-equipped drive shaft of the electric motor. In an embodiment, increased pressure applied by the user results in increased hair trimmer motor speed.

In an embodiment, the electric motor has a base rotational speed associated with the hair trimmer being turned on, and the partial actuation of the trigger increases the rotational speed of the electric motor beyond the base rotational speed. The user optionally controls the amount by which the rotational speed of the motor is increased by controlling the partial actuation of the trigger. Accordingly, the user is able to increase the speed of the electric motor precisely and for a limited duration as needed while cutting hair. This helps reduce power consumption of the battery, heat generation by the electric motor, vibration, and wear of the hair trimmer.

The trigger allows for any partial actuation in the continuous range of actuations between the minimum actuation and the maximum actuation. This provides additional flexibility to the user, as the user is not limited to discrete speed settings of the electric motor. Additionally, the trigger is located on a back half of a housing for the hair trimmer, in close proximity to a natural resting place of an index finger of the user. This helps improve the ergonomics of the hair trimmer and ease with which the user actuates the trigger. Further, an on-off switch of the hair trimmer is located on a front half, or a side surface, of the housing of the hair trimmer, such that the two operative controls of the hair trimmer are not disposed on the same side of the hair trimmer.

The present hair trimmer advantageously includes a digital display which displays an operational parameter of the hair trimmer. In one embodiment, the operational parameter includes a rotational speed of the electric motor associated with a maximum actuation of the trigger and a rotational speed of the electric motor associated with a minimum actuation of the trigger. In this embodiment, the digital display displays an rotational speed limit page which shows a current upper rotational speed limit associated with the maximum actuation and a current lower rotational speed limit associated with the minimum actuation. The hair trimmer advantageously includes a plurality of buttons disposed on the hair trimmer which include a menu button, an increase button, and a decrease button. The menu button allows the hair trimmer to enter upper and lower limit setting modes, where the user optionally increases or decreases the current upper and lower rotational speed limits for the electric motor, by use of the increase button, and the decrease button, respectively.

Thus, the user of the hair trimmer is able to conveniently see the upper and lower rotational speed limits for the electric motor based on the maximum and minimum actuation of the trigger, respectively. For example, a user is able to associate a particular rotational speed (e.g. 6750 rpm) as advantageous for cutting African American hair, but not Caucasian hair, and is able to set the rotational speeds for the minimum and maximum actuation of the trigger accordingly.

More specifically, an electric hair cutting device is provided, including a housing having a first end and a second end opposite the first end, a bladeset mounted to the housing at the first end, the bladeset having a stationary blade and a reciprocating blade, an electric motor electrically connected to a power source within the housing, a drive shaft operatively connecting the electric motor to the reciprocating blade, a control module within the housing which controls a rotational speed of the electric motor, and a trigger which sends an actuation signal to the control module based on a partial actuation of the trigger between a minimum actuation and a maximum actuation, the control module adjusting a rotational speed of the electric motor based on the actuation signal.

In an embodiment, the electric hair cutting device includes an on-off switch distinct from the trigger, such that activation of the on-off switch to an on-position causes the electric motor to rotate at a base rotational speed. The partial actuation of the trigger causes the electric motor to rotate at a rotational speed above the base rotational speed. The trigger allows for the partial actuation to be any actuation in a continuous range of actuations between the minimum actuation and the maximum actuation.

In another embodiment, the trigger is a mechanical trigger which is actuated between the minimum actuation and the maximum actuation based on an amount of pressure applied to the mechanical trigger. The mechanical trigger includes a force resistive sensor, and the force resistive sensor is disposed in a voltage divider circuit, such that the actuation signal corresponds to an output voltage from the force resistance sensor. In yet another embodiment, the mechanical trigger includes a push button connected to a pressure sensor, such that the actuation signal corresponds to a pressure value applied to the push button.

In yet another embodiment, the trigger is an optical sensor which is actuated between the minimum actuation and the maximum actuation by adjusting an amount of light received by the optical sensor.

In a further embodiment, the trigger is disposed on a back face of the housing in a location proximate to an index finger of a user of the electric hair cutting device. In further embodiments, the electric hair cutting device includes a lock which causes the trigger to remain in a particular actuation between the minimum actuation and the maximum actuation, and a safety which prevents actuation of the trigger.

In another embodiment, the electric hair cutting device includes a digital display disposed on the housing, such that the digital display is connected to the control module, and is configured to display a rotational speed value of the electric motor associated with the minimum actuation and a rotational speed value of the electric motor associated with the maximum actuation.

In a further embodiment, the electric hair cutting device includes a plurality of buttons disposed on the housing, each of the plurality of buttons being connected to the control module and being configured to send signals to the control module. Advantageously, the buttons include a menu button configured to place the electric hair cutting device in an upper rotational speed limit setting mode which allows adjustment of the rotational speed of the electric motor associated with the maximum actuation or a lower rotational speed limit setting mode which allows adjustment of a rotational speed of the electric motor associated with the minimum actuation; an increase button configured to increase the rotational speed of the electric motor associated with the minimum actuation and the maximum actuation; and a decrease button configured to decrease the rotational speed of the electric motor associated with the minimum actuation and the maximum actuation.

A second embodiment of the present disclosure includes an electric hair cutting device with a housing having a first end and a second end opposite the first end; a bladeset mounted to the housing at the first end, the bladeset having a stationary blade and a reciprocating blade; an electric motor electrically connected to a power source within the housing; a drive shaft operatively connecting the electric motor to the reciprocating blade; a control module within the housing which controls a rotational speed of the electric motor; a trigger which sends an actuation signal to the control module based on a partial actuation of the trigger between a minimum actuation and a maximum actuation, the control module adjusting a rotational speed of the electric motor based on the actuation signal; and a digital display disposed on the housing, the digital display being connected to the control module, and being configured to display an operational parameter of the electric hair cutting device.

In multiple embodiments, the operational parameter of the electric hair cutting device includes a rotational speed of the electric motor associated with the minimum actuation and a rotational speed of the electric motor associated with the maximum actuation, and the electric hair cutting device includes an on-off switch distinct from the trigger, such that activation of the on-off switch to an on-position causes the electric motor to rotate at a base rotational speed and causes the digital display to display the operational parameter of the electric hair cutting device.

### BRIEF DESCRIPTION OF THE DRAWINGS

FIG. 1 is a front perspective view the present electric hair cutting device;

FIG. 2 is an exploded front perspective view of the electric hair cutting device of FIG. 1;

FIG. 3 is a vertical cross-section view of the electric hair cutting device of FIG. 1;

FIG. 4 is a schematic diagram illustrating a control module, a trigger, and a graphical user interface of a display screen of the electric hair cutting device of FIG. 1;

FIG. 5A is a front plan view of a rotational speed limit setting page of the graphical user interface of the electric hair cutting device of FIG. 1;

FIG. 5B is a front plan view of the rotational speed limit setting page of FIG. 5A showing an upper rotational speed limit setting mode of the electric hair cutting device of FIG. 1;

FIG. 5C is a front plan view of the rotational speed limit setting page of FIG. 5A showing a lower rotational speed limit setting mode of the electric hair cutting device of FIG. 1;

FIG. 6 is a graphic representative of test data where voltage of a pressure sensor within the electric hair cutting device of FIG. 1 at various weights applied to the pressure sensor was compared; and

FIG. 7 is a graphic representative of test data where rotational speed of an electric motor within the electric hair cutting device of FIG. 1 at various voltages of the pressure sensor was compared.

### DETAILED DESCRIPTION

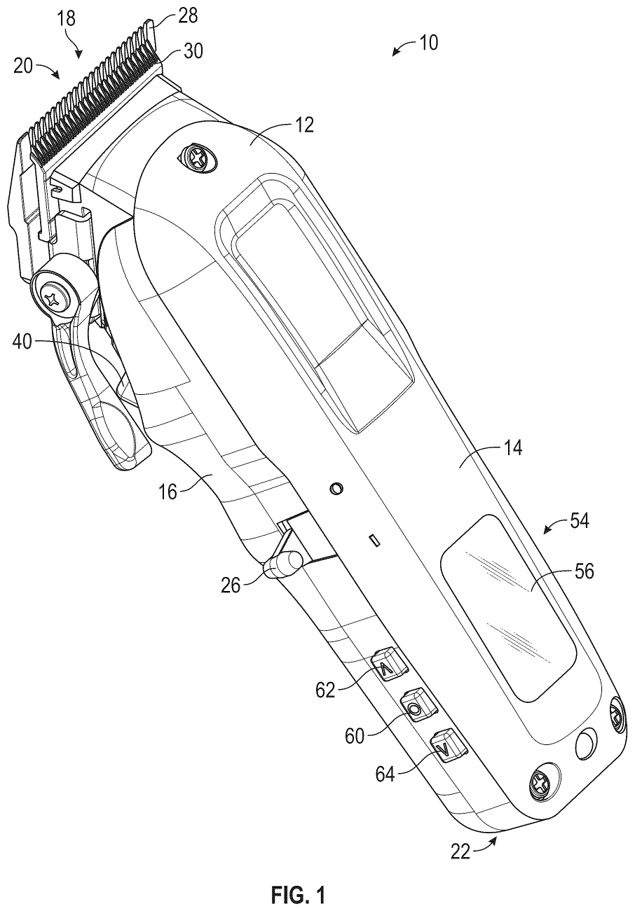

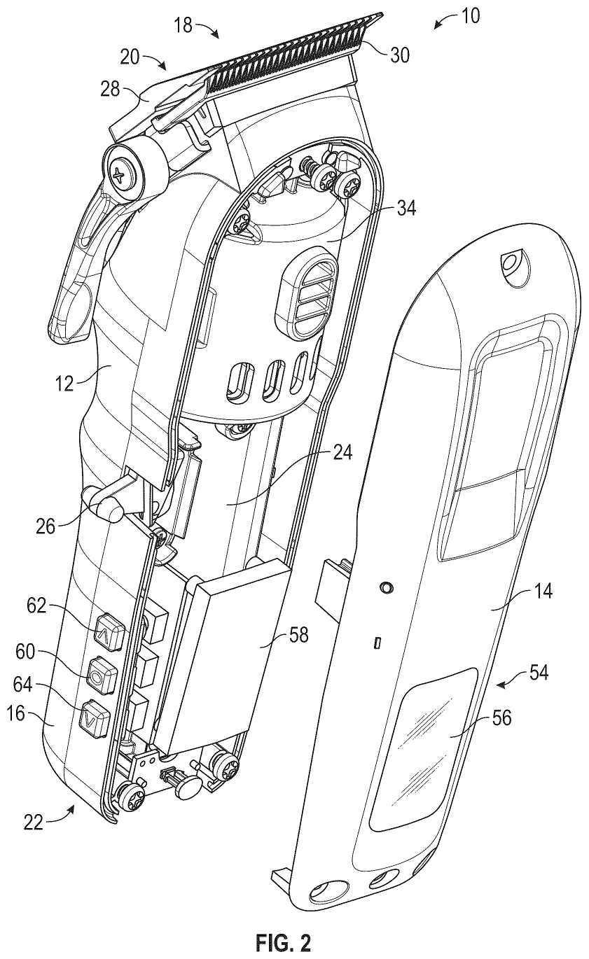

Referring now to FIGS. 1-3, in which the components are shown schematically and not to scale, an electric hair cutting device is generally designated 10 and is in the form of a hair trimmer. The hair trimmer 10 includes a housing, generally designated 12 incorporating a front housing half 14 and a back housing half 16. This depiction of hair trimmer 10 is exemplary only, as the present disclosure optionally relates to any electric hair cutting device having an electric motor to achieve the benefits herein.

Included on the housing 12 is a drive or working end 18, to which is mounted a bladeset 20, and an opposite rear end 22, configured for accommodating a charging cord for recharging an internal battery 24. It is also contemplated that the present hair trimmer 10 is alternately powered by wall voltage supplied by a traditional power cord. A power switch 26 on the housing 12 is used to turn the hair trimmer 10 on and off. Advantageously, the power switch 26 is a rocker switch disposed on a side of the housing 12, and more specifically a side of the back housing half 16.

The bladeset 20 includes a stationary blade 28 and a laterally reciprocating moving blade 30 driven by an eccentric cam-equipped drive shaft 32 of an electric motor 34. A control module 36, in the form of a circuit board 38, controls the operation of the electric motor 34, and receives power from the internal battery 24.

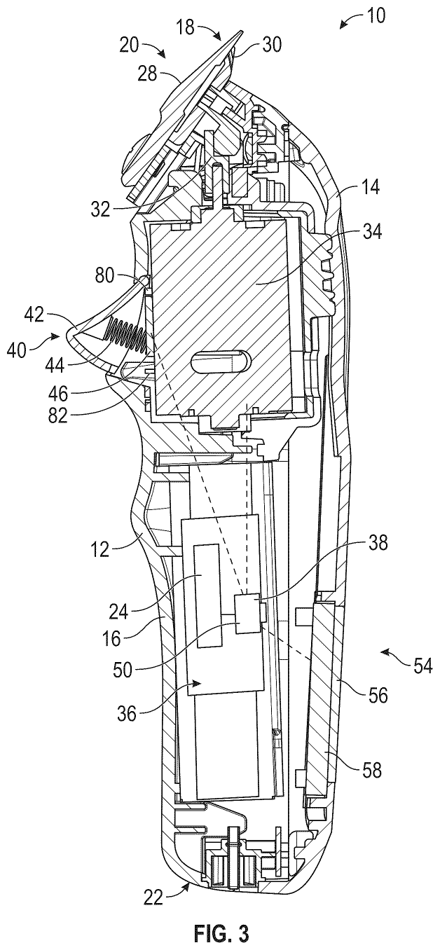

Referring now to FIG. 3, the back housing half 16 includes a trigger 40 which sends an actuation signal to the control module 36, and the control module uses the actuation signal to adjust the rotational speed of the electric motor 34, as discussed in greater detail below. The term “trigger” as used herein includes any type of user input expedient, including but not limited to mechanical devices, buttons, switches, sliders, pressure sensing devices, temperature sensing devices, light sensing devices, touch sensitive devices, microphones and related componentry for voice control, or any other device capable of receiving a user input. The trigger 40 is disposed at a location on the back housing half 16 in close proximity to a natural resting position of an index finger of a user of the hair trimmer 10, improving the ergonomics of the hair trimmer and ease with which the user actuates the trigger 40. It is envisioned that the trigger 40 may be situated anywhere on the hair trimmer 10 that is accessible to the user.

In an example embodiment, the trigger 40 takes the form of a push button 42 biased by a compression spring 44 away from the back housing half 16. Additionally, the trigger 40 includes a pressure sensor 46 which measures the pressure applied to the push button 42 and sends the actuation signal to the control module 36 based on the measured pressure. When the trigger 40 includes the push button 42, a minimum actuation of the trigger corresponds to a user applying zero pressure to the push button, while a maximum actuation of the trigger corresponds to the user compressing the push button to a maximum compression allowed by the compression spring 44.

The trigger 40 allows for partial actuation between the minimum and maximum actuation of the trigger. For example, when the user compresses the push button 42 by applying a pressure which compresses the compression spring 44 by 27% of the maximum allowed pressure, the pressure sensor 46 measures the pressure exerted on the push button corresponding to the 27% actuation and sends the actuation signal to the control module 36. The trigger 40 is optionally actuated at any percentage between the minimum actuation and the maximum actuation, and the actuation signal optionally corresponds the percentage by which the user actuated the trigger. In other words, the trigger 40 allows for any partial actuation in the continuous range of actuations between the minimum actuation and the maximum actuation.

The control module 36 operatively controls the speed at which the moving blade 30 laterally reciprocates relative to the stationary blade 28. In an embodiment, when the user turns on the hair trimmer 10 by activating the power switch 26, the control module 36 sends a base control signal to the electric motor 34 which causes the electric motor to drive the moving blade 30 at a base rotational speed. For example, in one embodiment, the base rotational speed corresponds to a rotational speed of the electric motor 34 which drives the eccentric cam-equipped drive shaft 32 of 6000 revolutions per minute (RPM). The base rotational speed corresponds to the minimum actuation of the trigger 40, when the trigger is not actuated.

After receiving the actuation signal, the control module 36 sends a control signal to the electric motor 34 to adjust the rotational speed of the eccentric cam-equipped drive shaft 32 above the base rotational speed. Specifically, as the partial actuation applied to the trigger 40 increases, the rotational speed of the eccentric cam-equipped drive shaft 32 also increases, until the trigger reaches the maximum actuation, where the eccentric cam-equipped drive shaft hits the maximum rotational speed. In an embodiment, as the electric motor 34 increases above the base rotational speed, the noise created by the electric motor also increases, providing audible confirmation to the user that the rotational speed of the electric motor has increased. Advantageously, the increase in noise from the electric motor 34 is roughly proportionally to the increase in actuation of the trigger 40. In this way, the user is able to gauge the sensitivity of the trigger 40 based on the increase in noise from the electric motor 34 with a given partial actuation.

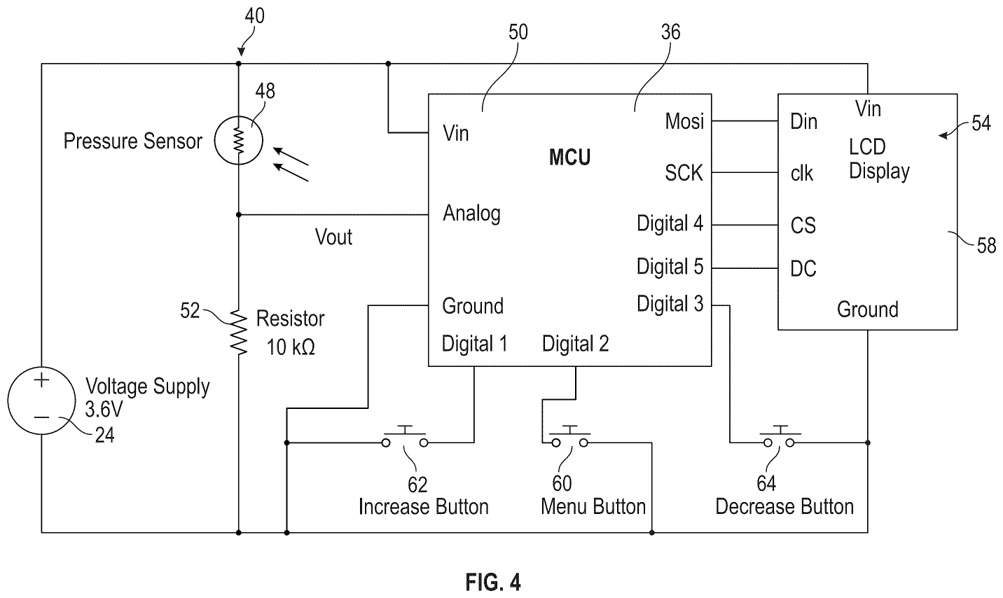

FIG. 4 illustrates a schematic diagram of components within an example embodiment of the hair trimmer 10, where the trigger 40 takes the form of a force resistive sensor 48, such as a strain gauge. The force resistive sensor 48 sends the actuation signal to the control module 36, which is shown as a micro-control unit 50. In the embodiment of FIG. 4, the force resistive sensor 48 is provided in a voltage divider circuit, where a resistor 52 is placed in series with the force resistive sensor. The actuation signal sent from the force resistive sensor 48 to the micro-control unit 50 is a voltage output from the force resistive sensor. Specifically, the force resistive sensor 48 has a large resistance value when no pressure is applied to the force resistive sensor, or when the force resistive sensor is at the minimum actuation. Accordingly, the voltage output from the force resistive sensor 48 is nominal when at the minimum actuation. However, as the force resistive sensor 48 is actuated between the minimum actuation and the maximum actuation, the resistance value of the force resistive sensor decreases, resulting in an increased output voltage being registered by the micro-control unit 50.

As the output voltage received by the micro-control unit 50 increases, the micro-control unit sends the control signal to the electric motor 34 to increase the driving speed of the eccentric cam-equipped drive shaft 32. Similarly, as the voltage value received by the micro-control unit 50 decreases, corresponding to a decrease in the partial actuation of the force resistive sensor 48, the micro-control unit sends a control signal to the electric motor 34 to decrease the driving speed of the eccentric cam-equipped drive shaft 32.

Referring to FIGS. 1-4, the hair trimmer 10 advantageously includes a digital display 54, which is optionally disposed on the front housing half 14. The digital display 54 includes a protective layer 56 disposed above a display screen 58, such that the protective layer is advantageously part of the front housing 14 and is made of a transparent material. The display screen 58 is connected to the micro-control unit 50 of the control module 36, such that the control module controls what is displayed on the display screen.

In the embodiment shown in FIGS. 1-4, the back half housing 14 includes a menu button 60, an increase button 62, and a decrease button 64. The term “button” as used herein includes any type of user input expedient, including but not limited to mechanical devices, buttons, switches, sliders, pressure sensing devices, temperature sensing devices, light sensing devices, touch sensitive devices, microphones and related componentry for voice control, or any other device capable of receiving a user input. Referring specifically to FIG. 4, the menu button 60, the increase button 62, and the decrease button 64 each provide data inputs to the micro-control unit 50, and the micro-control unit correspondingly adjusts what is displayed on the display screen 58.

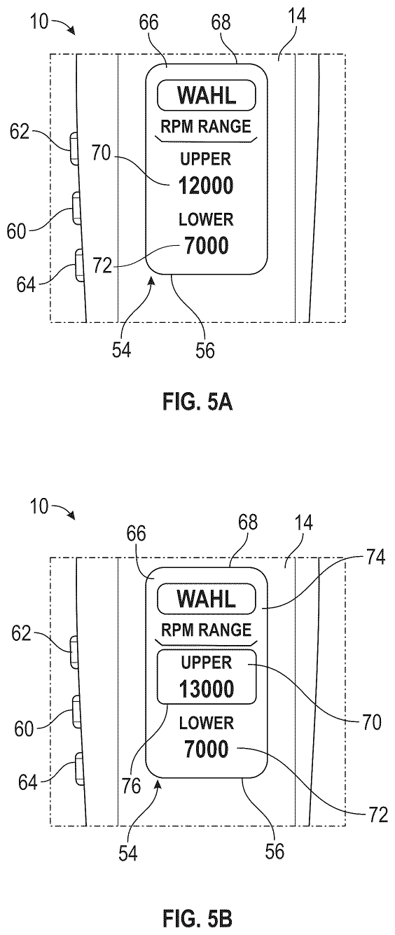

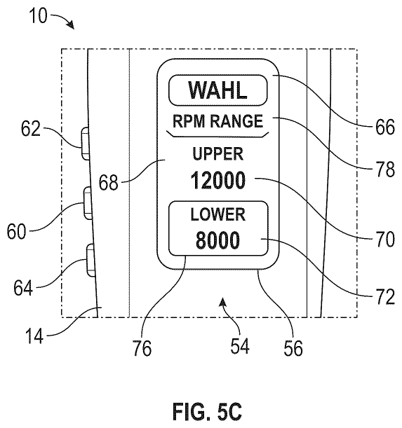

The display screen 58 advantageously displays a wallpaper 66 which displays an operational parameter of the hair trimmer 10. For example, in the embodiment shown in FIGS. 5A-5C, the wallpaper 66 displays a rotational speed limit setting page 68 which allows a user of the hair trimmer 10 to set a rotational speed of the electric motor 34 associated with minimum actuation of the trigger 40 and a rotational speed of the electric motor associated with maximum actuation of the trigger.

In this embodiment, when the user turns on the hair trimmer 10, as shown in FIG. 5a, the rotational speed limit setting page 68 displays a current upper rotational speed limit 70 associated with the maximum actuation and a current lower rotational speed limit 72 associated with the minimum actuation. In this embodiment, the upper rotational speed limit 70 has a default setting of 12,000 RPM, meaning that with a full actuation of the trigger 40, the rotational speed of the electric motor 34 is 12,000 RPM. Likewise, the lower rotational speed limit 72 has a default setting of 7,000 RPM meaning that in the unactuated state of the hair trimmer 10, when the trigger 40 is not actuated, the rotational speed of the electric motor 34 is 7,000 RPM. While FIGS. 5A-5C show the default upper rotational speed limit 70 and the default lower rotational speed limit 72 as being 12,000 RPM and 7,000 RPM, respectively, it is understood that alternate RPM values are optionally used for the upper and lower RPM limits. Thus, the operational parameter depicted on the display screen in FIGS. 5A-5C includes the rotational speed of the electric motor 34 associated with the upper rotational speed limit 70 and the lower rotational speed limit 72.

As shown in FIG. 5b, when the user presses the menu button 60 for a predetermined period of time, the display screen enters an upper limit setting mode 74 where the user optionally increases or decreases the upper rotational speed limit 70 for the hair trimmer 10. Advantageously, when the hair trimmer 10 is in the upper limit setting mode 74, the digital display 54 shows an indicator 76 proximate to the upper rotational speed limit 70, which indicates that the hair trimmer is in the upper limit setting mode. While the embodiment of FIGS. 5A-5C show the indicator 76 as a box which surrounds the upper rotational speed limit 70, it is appreciated that the indicator optionally takes the form of different shapes or symbols which are proximate to the upper rotational speed limit 70.

Once in the upper limit setting mode 74, a user optionally increases the upper rotational speed limit 70 by pressing the increase button 62 for a specific amount of time which corresponds to a desired increase in the upper rotational speed limit. Likewise, a user optionally decreases the upper rotational speed limit 70 by pressing the decrease button 64 for a specific amount of time which corresponds to a desired decrease in the upper rotational speed limit. Once the user has adjusted the upper rotational speed limit 70 to the desired value, the user optionally presses the menu button 60 for a second predetermined period of time to set the upper rotational speed limit at the desired value.

After the upper rotational speed limit 70 has been set, the user advantageously presses the menu button 60 for a third predetermined period of time, and the display screen enters a lower limit setting mode 78 where the user optionally increases or decreases the lower rotational speed limit 72 for the hair trimmer 10. Specifically, by pressing the increase button 62, the user optionally increases the lower rotational speed limit 72 by a desired amount. Similarly, by pressing the decrease bottom 64, the user optionally decreases the lower rotational speed limit 72 by a desired amount.

As with the upper limit setting mode 74, when the hair trimmer 10 is in the lower limit setting mode 78, the digital display 54 shows the indicator 76 proximate to the lower rotational speed limit 72, which indicates that the hair trimmer is in the lower limit setting mode. Once the user has adjusted the lower rotational speed limit 72 to the desired value, the user optionally presses the menu button 60 for a fourth predetermined period of time to set the lower rotational speed limit at the desired value.

Advantageously, when the hair trimmer 10 is in the upper limit setting mode 74 and the lower limit setting mode 78, the electric motor 34 is not operating and the moving blade 30 remains stationary. After the upper and lower rotational speed limits 70, 72 have been set, the electric motor 34 resumes operation and the moving blade begins to move at the lower rotational speed limit.

If desired, the user optionally sets a specific rotational speed for electric motor 34 by setting the upper and lower rotational speed limits 70,72 to be the same value. In this way, actuation of the trigger has no effect on the rotational speed of the electric motor 34.

It is contemplated that an operational parameter of the hair trimmer 10 is the current rotational speed of the electric motor 34, such that the digital display 54 shows, in real-time, a digital readout of the current rotational speed of the electric motor. Specifically, when the user of the hair trimmer 10 activates the trigger 40, resulting in the electric motor 34 having a particular rotational speed, the micro-control unit 50 sends a signal to the digital display 54 to display the particular rotational speed. Thus, when the user of the hair trimmer 10 throttles the trigger 40 to increase or decrease the rotational speed of the electric motor 34, the digital display 54 changes accordingly, by at least one of numerical display, brightness, color or flashing sequence.

The wallpaper 66 optionally takes various forms, each of which are advantageously selected by a user of the hair trimmer 10. For example, the display screen 58 advantageously includes different wallpaper 66 based on the desired operational parameter shown on the display screen. For example, the digital display 54 advantageously includes a battery icon which allows the user to view a battery screen which displays information about the current state of the internal battery 24 such as the battery percentage, the available run time, the time to full charge, the charging rate, etc. Advantageously, the user changes the wallpaper 66 displayed on the digital display 54 by using the menu button 60.

Various parameters are optionally considered as being the at least one operational parameter. For example, with regard to the moving blade 30, a non-limiting list of operational parameters advantageously includes a temperature of the moving blade, a remaining life of the moving blade, a blade type of the moving blade, a blade offset of the moving blade (such 0.1 mm offset, 0.2 mm offset, etc.), and a taper lever setting of the moving blade.

Moreover, with regard to the internal battery 24 of the hair trimmer 10, a non-limiting list of operational parameters advantageously includes the remaining voltage or current of the internal battery, the remaining available runtime of the internal battery, the temperature of the internal battery, the amount of time until a full charge of the internal battery, the charge cycles of the internal battery, and the battery health of the internal battery.

Regarding the electric motor 34, a non-limiting list of operational parameters advantageously includes the rotational speed of the electric motor, the current supplied to the electric motor, the voltage supplied to the electric motor, the temperature of the electric motor, the locked rotational speed at which a lock 80 is set to hold the trigger 40 at a partial actuation, a rotational speed setting of the electric motor (e.g. High/Medium/Low) which is displayed in conjunction with the actual rotational speed, and the adjustable torque of the electric motor.

Moreover, the hair trimmer 10 optionally includes sensors used to measure the at least one operational parameter of the hair trimmer 10. For example, when the at least one operational parameter is the temperature of the moving blade 30, the hair trimmer includes a temperature sensor (not shown) which measures the temperature of the moving blade. Further, the control module 36 advantageously performs the relevant calculations to determine the at least one operational parameter, when appropriate.

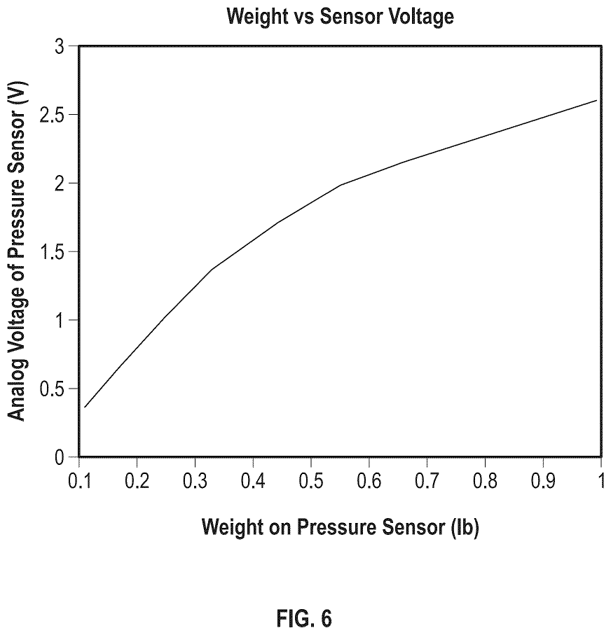

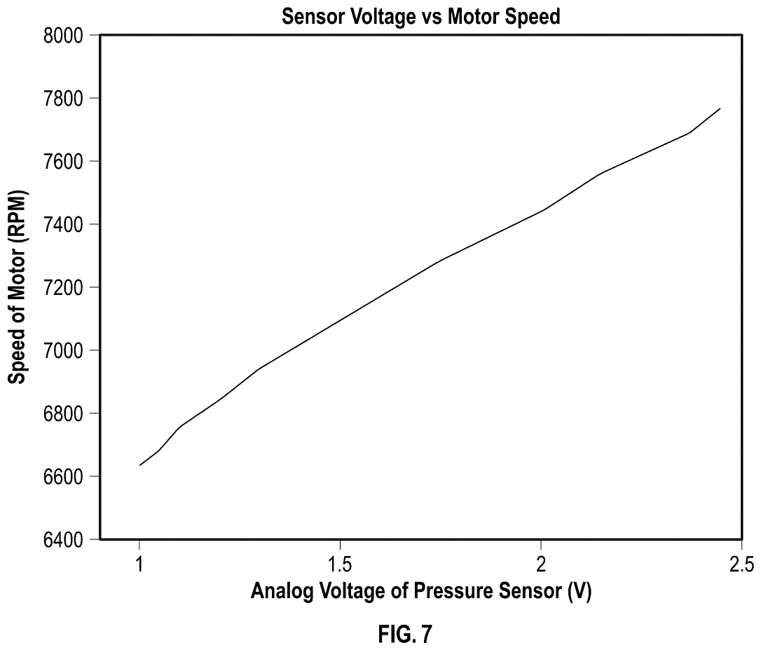

FIG. 6 is a graph which plots the voltage output of the force resistive sensor 48 compared to the weight applied to the force resistive sensor. As shown in FIG. 5, as the weight on the force resistive sensor 48 increases, the output voltage to the micro-control unit 50 also increases. Likewise, FIG. 6 is a graph which plots the output voltage from the force resistive sensor 48 compared to the rotational speed of the electric motor 34. As the output voltage from the force restive sensor 48 increases, the rotational speed of the electric motor 34 also increases.

While FIGS. 3-4 show the trigger 40 as being either the push button 42 or the force resistive sensor 48, as mentioned above, alternate devices, such as a slider, an optical sensor, a temperature sensor, or other similar electronic or mechanical user interfaces may be optionally used as the trigger. For example, when the trigger 40 is an optical sensor, the partial actuation between the minimum actuation and the maximum actuation is adjusted based on an amount of light received by the optical sensor.

Additionally, in certain embodiments, the hair trimmer 10 includes the lock 80 which allows the user to set a particular partial actuation of the trigger 40. Further, a mechanism 82 may be included which locks the trigger 40 in the minimum partial actuation, so that the electric motor 34 is prevented from increasing in rotational speed above the base minimum rotational speed. The present hair trimmer 10 is advantageously charged by a charging stand, such as the charging stand described in U.S. Provisional Application No. 63/700,255 filed Sep. 27, 2024, the entire contents of which are incorporated by reference herein.

The systems and devices described above optionally include a control module or a computing device comprising a processing and a memory having stored computer-executable instructions for implementing the above-described processes described. The processing unit optionally includes any suitable devices configured to cause a series of steps to be performed so as to implement the method such that instructions, when executed by the computing device or other programmable apparatus, optionally causes the functions/acts/steps specified in the methods described above to be executed. The processing unit optionally includes, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory optionally is any suitable known or other machine-readable storage medium. The memory optionally includes non-transitory computer readable storage medium such as, for example, but not limited to, an electronic, magnetic, optical, electromagnetic, infrared, or semiconductor system, apparatus, or device, or any suitable combination of the foregoing. The memory optionally includes a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory also contemplates any storage configuration (e.g., devices) suitable for retrievably storing the computer-executable instructions executable by processing unit.

The methods and systems described above is optionally implemented in a high-level procedural or object-oriented programming or scripting language, or a combination thereof, to communicate with or assist in the operation of the control module or computing device. Alternatively, the methods and systems described above are optionally implemented in assembly or machine language. The language is optionally a compiled or interpreted language. Program code for implementing the methods and systems described here are optionally stored on the storage media or the device, for example a ROM, a magnetic disk, an optical disc, a flash drive, or any other suitable storage media or device. The program code is optionally readable by a general or special-purpose programmable computer for configuring and operating the computer when the storage media or device is read by the computer to perform the procedures described above.

Computer-executable instructions are optionally in many forms, including modules, executed by one or more computers or other devices. Generally, modules include routines, programs, objects, components, data structures, etc., that perform particular tasks or implement particular abstract data types. Typically, the functionality of the modules are optionally combined or distributed as desired in various embodiments.

While a particular embodiment of the electric hair cutting device having user input dependent speed control has been described herein, it will be appreciated by those skilled in the art that changes and modifications may be made thereto without departing from the invention in its broader aspects and as set forth in the following claims.

All references, including publications, patent applications, and patents cited herein are hereby incorporated by reference to the same extent as if each reference were individually and specifically indicated to be incorporated by reference and were set forth in its entirety herein.

The term “electric hair cutting device” as used herein includes any electric hair cutting device that includes a motor which drives a moving blade to cut hair, including but not limited to hair clippers, hair trimmers, and electric shavers. The terms “hair clipper” and “hair trimmer” are used interchangeably unless otherwise noted, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric hair cutting device, comprising:
a housing having a first end and a second end opposite said first end;
a bladeset mounted to said housing at said first end, said bladeset comprising a stationary blade and a reciprocating blade;
an electric motor electrically connected to a power source within said housing;
a drive shaft operatively connecting said electric motor to said reciprocating blade;
a control module within said housing which controls a rotational speed of said electric motor; and
a trigger which sends an actuation signal to said control module based on a partial actuation of said trigger between a minimum actuation and a maximum actuation, said control module adjusting a rotational speed of said electric motor based on said actuation signal.

2. The electric hair cutting device of claim 1, further comprising an on-off switch distinct from said trigger, such that activation of said on-off switch to an on-position causes said electric motor to rotate at a base rotational speed.

3. The electric hair cutting device of claim 2, wherein said partial actuation of said trigger causes said electric motor to rotate at a rotational speed above the base rotational speed.

4. The electric hair cutting device of claim 1, wherein said trigger allows for said partial actuation to be any actuation in a continuous range of actuations between said minimum actuation and said maximum actuation.

5. The electric hair cutting device of claim 1, wherein said trigger is a mechanical trigger which is actuated between said minimum actuation and said maximum actuation based on an amount of pressure applied to said mechanical trigger.

6. The electric hair cutting device of claim 5, wherein said mechanical trigger comprises a force resistive sensor, and wherein said force resistive sensor is disposed in a voltage divider circuit, such that said actuation signal corresponds to an output voltage from said force resistance sensor.

7. The electric hair cutting device of claim 5, wherein said mechanical trigger comprises a push button connected to a pressure sensor, such that said actuation signal corresponds to a pressure value applied to said push button.

8. The electric hair cutting device of claim 1, wherein said trigger is an optical sensor which is actuated between said minimum actuation and said maximum actuation by adjusting an amount of light received by said optical sensor.

9. The electric hair cutting device of claim 1, wherein said trigger is disposed on a back face of said housing in a location proximate to an index finger of a user of said electric hair cutting device.

10. The electric hair cutting device of claim 1, further comprising a lock which causes said trigger to remain in a particular actuation between said minimum actuation and said maximum actuation.

11. The electric hair cutting device of claim 1, further comprising a safety which prevents actuation of said trigger.

12. The electric hair cutting device of claim 1, further comprising:
a digital display disposed on said housing, said digital display being connected to said control module, and being configured to display a rotational speed of said electric motor associated with said minimum actuation and a rotational speed of said electric motor associated with said maximum actuation.

13. The electric hair cutting device of claim 12, further comprising:
a plurality of buttons disposed on said housing, each of said plurality of buttons being connected to said control module and being configured to send signals to said control module, said plurality of buttons including:
a menu button configured to place the electric hair cutting device in an upper limit setting mode which allows adjustment of said rotational speed of said electric motor associated with said maximum actuation or a lower limit setting mode which allows adjustment of said rotational speed of said electric motor associated with said minimum actuation;
an increase button configured to increase said rotational speed of said electric motor associated with said minimum actuation and said maximum actuation; and
a decrease button configured to decrease said rotational speed of said electric motor associated with said minimum actuation and said maximum actuation.

14. An electric hair cutting device, comprising:
a housing having a first end and a second end opposite said first end;
a bladeset mounted to said housing at said first end, said bladeset comprising a stationary blade and a reciprocating blade;
an electric motor electrically connected to a power source within said housing;
a drive shaft operatively connecting said electric motor to said reciprocating blade;
a control module within said housing which controls a rotational speed of said electric motor;
a trigger which sends an actuation signal to said control module based on a partial actuation of said trigger between a minimum actuation and a maximum actuation, said control module adjusting a rotational speed of said electric motor based on said actuation signal, and
a digital display disposed on said housing, said digital display being connected to said control module, and being configured to display an operational parameter of the electric hair cutting device.

15. The electric hair cutting device of claim 14, wherein said operational parameter of the electric hair cutting device includes a rotational speed of said electric motor associated with said minimum actuation and a rotational speed of said electric motor associated with said maximum actuation.

16. The electric hair cutting device of claim 15, further comprising:
a plurality of buttons disposed on said housing, each of said plurality of buttons being connected to said control module and being configured to send signals to said control module, said plurality of buttons including:
a menu button configured to place the electric hair cutting device in an upper limit setting mode which allows adjustment of said rotational speed of said electric motor associated with said maximum actuation or a lower limit setting mode which allows adjustment of said rotational speed of said electric motor associated with said minimum actuation;
an increase button configured to increase said rotational speed of said electric motor associated with said minimum actuation and said maximum actuation; and
a decrease button configured to decrease said rotational speed of said electric motor associated with said minimum actuation and said maximum actuation.

17. The electric hair cutting device of claim 14, further comprising an on-off switch distinct from said trigger, such that activation of said on-off switch to an on-position causes said electric motor to rotate at a base rotational speed and causes said digital display to display said operational parameter of the electric hair cutting device.

18. The electric hair cutting device of claim 17, wherein said partial actuation of said trigger causes said electric motor to rotate at a rotational speed above the base rotational speed.

19. The electric hair cutting device of claim 14, wherein said trigger is a mechanical trigger which is actuated between said minimum actuation and said maximum actuation based on an amount of pressure applied to said mechanical trigger.

20. The electric hair cutting device of claim 14, further comprising:
a lock which causes said trigger to remain in a particular actuation between said minimum actuation and said maximum actuation;
a safety which prevents actuation of said trigger; or
both.
